(19) United States
(12) Patent Application Publication
(10) Pub. No.: US 2005/0146754 A1
(43) Pub. Date: Jul. 7, 2005

(54) Multi-functional printer device

(76) Inventor: Jonathan Firooz, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/750,804

(22) Filed: Jan. 2, 2004

(51) Int. Cl. H04N 1/00; G06F 15/00

(52) U.S. Cl. 358/440; 358/448; 358/1.15

(57) ABSTRACT

A method for receiving facsimiles in a multi-function printer device, the method comprises answering, by the multi-function printer device, an incoming phone call, playing, by the multi-function printer device, an outgoing communication, monitoring, by the multi-function printer device, the incoming phone call to detect a facsimile tone, generating, by the multi-function printer device, a ring on a telephone out-port of the device in response to no facsimile tone being detected during the monitoring, and initializing the multi-function printer device to receive an incoming facsimile transmission in response to a facsimile tone being detected during the monitoring.

### CROSS-REFERENCE TO RELATED APPLICATIONS

This application is related to commonly assigned and concurrently filed U.S. patent application Ser. No. ______ [Attorney Docket No. 200205924-1] entitled “MULTI-FUNCTIONAL PRINTER DEVICE”, and Ser. No. ______ [Attorney Docket No. 200205925-1] entitled “MULTI-FUNCTIONAL PRINTER DEVICE”, the disclosures of which are incorporated herein by reference.

### FIELD OF THE INVENTION

The present invention is broadly related to multi-function printers, and more specifically to a multi-function printer device capable of generating a ring on a telephone line-out.

### DESCRIPTION OF RELATED ART

Initially, facsimile, or fax, technology was primarily developed for commercial use as a means of transmitting copies of documents without employing conventional mail or courier services. The standard fax machine can be connected to a dedicated telephone line that is not shared by any other device, such as an answering machine in a consumer setting, or even a credit card reader in a commercial setting. For some businesses it is typically not a great burden to pay a few extra dollars per month for a separate line for a critical device such as a fax machine.

However, it is becoming more common and more useful for consumers and small businesses to have fax capability. Yet, consumers and small businesses that cannot dedicate a line to a fax machine are may have additional burdens. For example, conflicts can arise between an answering machine and a traditional fax machine in that most fax machines will answer after a certain number of rings, in a fashion similar to a typical answering machine. Thus, in unattended situations, one device will pick-up, preempting operation of the other device. In some instances, consumers and small businesses that cannot dedicate a line to a fax machine may either receive voice messages or unattended faxes, but not both.

Modern multi-function printers, also known as all-in-one devices, may include fax, as well as copy, scan and print capability. A user wanting to use the fax functionality of a multi-function printer device would typically either turn off their answering machine when they expect a fax, or conversely turn off the fax when they expect a voice message, unless they subscribe to separate phone lines for each device.

### BRIEF SUMMARY OF THE INVENTION

An embodiment of a method for receiving facsimiles in a multi-function printer device, the method comprises answering, by the multi-function printer device, an incoming phone call, playing, by the multi-function printer device, an outgoing communication, monitoring, by the multi-function printer device, the incoming phone call to detect a facsimile tone, generating, by the multi-function printer device, a ring on a telephone out-port of the device in response to no facsimile tone being detected during the monitoring, and initializing the multi-function printer device to receive an incoming facsimile transmission in response to a facsimile tone being detected during the monitoring.

An embodiment of a multi-function printer device comprises means for printing media, means for optically scanning media, means for answering incoming phone calls, means for sending and receiving facsimiles, means for playing an outgoing communication, means for monitoring the incoming phone calls and detecting an incoming facsimile tone, means for generating a ring on a telephone out-line in response to the monitoring means not detecting an incoming facsimile tone, and means for initializing the facsimile means to receive an incoming facsimile transmission in response to the monitoring means detecting an incoming facsimile tone.

An embodiment of a system for providing a multi-function printer device a capability for routing calls comprises a multi-function printer device comprising a printer, an optical scanner, a call answering functionality and a facsimile functionality, wherein the multi-function printer device answers and monitors incoming phone calls to internally intercept incoming calls, initialize the facsimile functionality to receive incoming facsimile transmissions, and generate a ring on a connected telephone for non-fax calls and the system also comprises a general purpose processor-based device selectively interfaced with the multi-function printer device and selectively powered.

### BRIEF DESCRIPTION OF THE DRAWINGS

FIG. 1 illustrates a system employing an embodiment of the present invention; and

FIG. 2 is a flowchart of an embodiment of the present invention.

### DETAILED DESCRIPTION

The present systems and methods provide an “all-in-one” multi-function printer device with a capability to intelligently monitor incoming calls to determine whether the incoming call is a fax transmission or a voice transmission and respond to, or switch, the call appropriately. The present systems and methods provide an artificial ring generated by the multi-function printer device on its out-line port when a non-fax call is detected. In accordance with embodiments of the present invention, when a call is received the multi-function printer device immediately answers the call and may play a brief outgoing communication. This communication may not necessarily be an answering machine type outgoing message, but rather something as simple as a “please wait” statement. The purpose of such a message is that a person calling in with a voice call will understand what “please wait” means, and they will preferably wait. A fax machine, on the other hand, may not be affected by the message and will preferably proceed to send a fax tone to initiate a fax handshake and fax transmission. If the multi-function printer device detects a fax tone, the device initializes and receives the fax and terminates the call upon completion of the fax transmission. If the multi-function printer device does not sense a fax tone then the device preferably generates a ring, for example on an line-out port, so that a connected communications device such as a telephone or answering machine rings and the user, or user's answering machine, may pick up. As an alternative to playing the brief outgoing message, the multi-function printer device's outgoing communication may be a simulation of a ring tone on the line-in, while the multi-function printer device monitors for a fax tone and generates the ring on the line-out port.

In alternative embodiments, an answering machine or voicemail functionality may be built into the present multi-function printer device. In such alternative embodiments, if no fax tone is detected and a predetermined number of generated rings on the line-out does not result in the call being answered, the device's voicemail functionality may pick up a call and carry out voicemail operations.

In further alternative embodiments, the multi-function printer device may answer an incoming call, determine whether the incoming call is a fax transmission by monitoring for a fax tone and then generate a ring on the multi-function printer device itself, rather than, or in addition to, generating the ring on the line-out port.

In yet further alternative embodiments, the multi-function printer device may generate more than one distinctive rings or tones to indicate a type of call. By way of example, the multi-function printer device may answer an incoming call, determine whether the incoming call is a fax transmission by monitoring for a fax tone and then generate one distinctive ring, either on the multi-function printer device itself or on the line-out port to indicate the call is a fax call, or generate a second distinctive ring, or “standard” ring, to indicate that the incoming call is a voice, or non-fax, call.

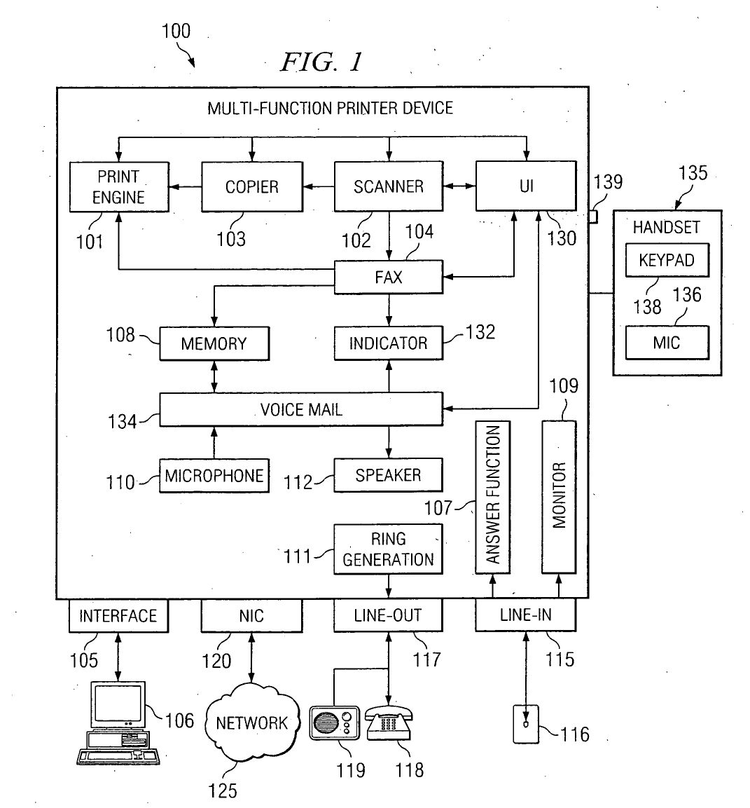

FIG. 1 is a diagrammatic illustration of an embodiment of “all-in-one” multi-function printer device 100 provided in accordance with embodiments of the present invention. Multi-function printer device 100 has a print engine or media printing functionality 101 and media scanning functionality 102. Printing functionality 101 may be of several media printing types known in the art, such as laser or inkjet and may be black-and-white (grayscale) or color. Scanning functionality 102 may include technologies such as a flatbed optical scanner, a picture frame scanner, or the like. Preferably, printing and scanning functionalities 101 and 102 may be used in conjunction with connected general purpose processor-based device 106, such as a personal computer (PC) or the like. Also, scanning functionality 102 and printing functionality 101 together may provide copier functionality 103 either in a stand-alone fashion, without a need for any processing by general purpose processor-based device 106, and/or in conjunction with connected general purpose processor-based device 106.

Fax functionality 104 may use printing functionality 101 for printing received faxes and fax functionality 104 may receive scanned images from scanning functionality 102 to be used as outgoing faxes. Multi-function printer device 100 preferably has interface 105 for optionally interfacing with general purpose processor based device 106. Interface 105 may take the form of a parallel port, Universal Serial Bus (USB) port, FireWire (IEEE 1394) port, or the like. However, multi-function printer device 100 may operate as a stand-alone device, at least as an integrated stand-alone copier and/or fax device, without the need to be connected to general purpose processor based device 106, or without any need for general purpose processor based device to be in a powered-on status, if connected. Phone line-in 115 is preferably connected to a wall phone jack 116 or the like and phone line-out 117 may optionally be connected to at least one communication device such as telephone 118, answering machine 119, or the like. Phone line-in 115 and phone line-out 117 may be decoupled in present multi-function printer device 100, wherein the line-in and line-out ports of the present multi-function printer device may be independently addressed, and a signal sent to one port may not be provided at the other port. Present multi-function printer device 100 employs decoupled line-in and line-out ports so that the ports may be treated separately, such that when the initial ring is received on line-in port 115, connected answering machine 119 or phone 118 on line-out port 117 does not ring.

Multi-function printer device 100 also includes call answering functionality 107 that answers calls, preferably on or before a first ring and plays a short outgoing message to the caller, such as “please wait.” Alternatively, answering functionality 107 may present an artificial ring tone to the caller, for example by playing a WAV file of a ring tone, or in a similar manner. Monitoring functionality 109 monitors the answered call for a fax tone. In most cases, if the call is from a fax machine the multi-function printer device will detect a standard tone sent by the fax machine to initiate fax synchronization. If this tone is detected multi-function printer device fax functionality 104 will preferably connect to the call in a fax reception mode. However, if the call is from a person then no tone will be present, in which case the multi-function printer device's ring generation functionality 111 generates a ring on line-out 117 to ring phone 118 or answering machine 119. Monitor 109 may continue to monitor for a fax tone during the generated rings in case an incoming fax tone was missed or delayed. Additionally, multi-function printer device 100 may also continue to monitor the line for incoming sound, such as a voice. If no incoming sound, is detected during a call the present systems and methods may initiate a fax receive lest a sending fax machine is not employing an initiating fax tone.

Memory 108 resident in multi-function printer device 100 may be used to store received faxes, outgoing message(s) and/or incoming messages for voice mail functionality 134 discussed below. Memory 108 may take the form of volatile memory such as Random Access Memory (RAM), nonvolatile memory such as Read Only Memory (ROM) and/or Erasable Programmable Read Only Memory (EPROM) or a combination of volatile and nonvolatile memory. A combination of volatile and nonvolatile memory may, for example, use volatile memory to store transient data such as incoming faxes or messages while nonvolatile memory may be used to store more permanent data such as default and/or user selected device settings, outgoing message(s) or other WAV files, and the like. Memory 108 may be in addition to typical RAM or other memory associated with printer, scanner and/or copier functionality 101, 102 and/or 103. Memory 108 may be internal to multi-function printer device 100. However, RAM or other memory associated with general purpose processor based device 106 may also or alternatively be employed to store incoming faxes, incoming messages, device settings, and/or the like. Multi-function printer device 100 may additionally, or alternatively, include one or more slots to receive memory devices such as smart media, compact flash, IC media, or the like, for storing faxes in addition to more conventional uses such as providing pictures directly to printer functionality 101. Alternatively, if multi-function printer device 100 is connected to general purpose processor-based device 106 and general purpose processor-based device 106 is powered on, general purpose processor-based device 106's hard drive or other storage media may be used to store faxes and/or incoming voice messages. Thereby, general purpose processor-based device 106 may be used to display the faxes or replay voice messages, such as at a later time.

As noted above, embodiments of multi-function printer device 100 may be used as a stand-alone device. User interface (UI) 130 may facilitate such stand-alone operation, and preferably may also be employed when the present multi-function printer device is employed in conjunction with general purpose processor-based device 106. Interface 130 may, among other functions related to printing, scanning and copying, facilitate sending of faxes and manual receiving of faxes, as well as providing an interface for user selection of device settings, recording of one or more outgoing greeting messages, retrieval of voice messages, downloading of faxes or messages to memory devices, and/or other operations related to multi-function printer device 100. Alternatively or additionally, a user interface may be provided on general purpose processor-based device 106. A computer provided UI may utilize a microphone and/or speaker system associated with general purpose processor-based device 106 rather than (or in addition to) employing microphone 110 and speaker 112 of multi-function printer device 100. However, once set-up using the computer provided UI, multi-function printer device 100 will still preferably be able to function as a stand-alone device without the computer turned on and/or connected, only using the computer UI for configuration changes. Also, as a default, multi-function printer device 100 is preferably enabled to function as a fax and answering system without any configuration using UI 130 or a computer provided UI, through the use of default settings and greetings. Indicator 132, that may be a part of UI 130, may provide a visual and/or audio indication of one or more stored faxes and/or voice messages.

As noted above, multi-function printer device 100 may also include voicemail functionality 134 that provides outgoing messages and records incoming messages. Preferably, voicemail functionality 134 is available when the multi-function printer device 100 operates in a stand-alone mode as discussed above. Also as noted above, memory 108 may be used to store an outgoing voice message(s) and incoming voice messages. Multi-function printer device 100 may also include microphone 110 that may be used to record outgoing messages. Speaker 112 may be used during playback of messages or when screening calls, particularly when general purpose processor-based device 106 is not used in conjunction with multi-function printer device 100 for message playback and call screening. Alternatively, phone handset 135 may be associated with multi-function printer device 100, particularly an embodiment employing voicemail functionality 134. Microphone 136 of handset 135 may be used rather than microphone 110 for recording answering machine outgoing messages and the like. Alternative keypad 138 associated with handset 135 may be incorporated into handset 135 or may be disposed on the body of multi-function printer device 100, such as in a multi-function keypad employed by multi-function printer device 100 as part of user interface 130 or a special purpose phone keypad disposed in association with a handset receptive structure and/or hook switch 139.

Network interface 120, such as an Ethernet port, may also be provided by multi-function printer device 100 to provide interconnectivity to network 125 such as a wired local area network, a wide area network or the Internet. Multi-function printer device 100 may also, or alternatively, employ one or more wireless technologies such as IEEE 802.11 wireless networking, BULETOOTH™, infrared (IR), or the like, to provide connectivity with general purpose processor-based device 106, network 125 and/or other devices or services such as a Personal Digital Assistant (PDA), a wireless local area network, and/or the like.

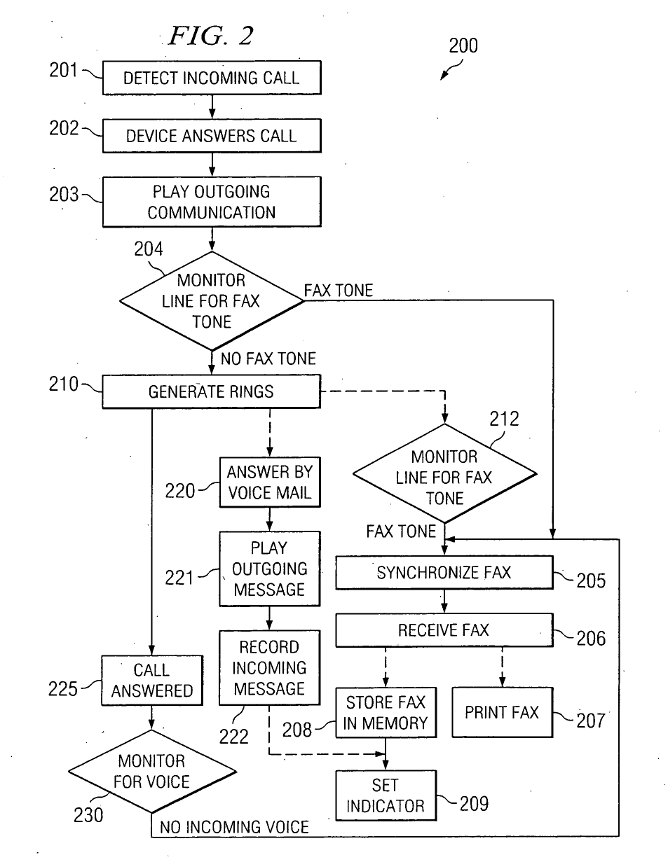

FIG. 2 flowcharts operation of an embodiment of present method 200 for generating a ring by an “all-in-one” multi-function printer device when a non-fax call is detected. An incoming call is detected by the present device at 201. As soon as a call is detected at 201, the multi-function printer device immediately answers the call at 202 preferably before a first ring. The multi-function printer device plays an outgoing message at 203, preferably a brief message such as “please wait”, and monitors the line at 204. Alternatively, the multi-function printer device may generate an artificial ring tone for the caller at 203. This ring may be generated by playing a WAV file or other sound file back to the caller. If a fax tone is detected during monitoring at 204, the multi-function printer device preferably synchronizes and negotiates with the fax machine at 205 to receive the fax transmission at 206. The received fax may be stored in memory at 208 and/or printed using the printer functionality of the device at 207. This memory may be internal to the multi-function printer device or may be associated with a connected general purpose processor-based device. If a fax tone is not detected after some specified period of time, that may be preset or user settable, or a voice is detected, the device generates a ring on the line-out port at 210 so that any attached answering machine or phone will ring. The multi-function printer device will then operate in a conventional fashion such that the answering machine will answer or a person can answer the phone. Alternatively, the multi-function printer device may continue to monitor the line after the device has created the artificial ring tone at 212 so that if a delayed fax tone is detected, the multi-function printer device may interrupt the call and negotiate, receive, and store or print the fax.

Alternatively, the multi-function printer device may both print (207) and store (208) the received fax. The multi-function printer device may store the received fax at 208 concurrently with receipt of the fax at 206, prior to disconnecting, concurrently with disconnecting or following disconnecting. Preferably, if a received fax is stored at 208, an audio and/or visual indicator is set at 209. As a further alternative, if the all-in-one multi-function printer device is out of paper or otherwise incapable of printing at the time a fax is received, the multi-function printer device may store an incoming fax in memory and set an indicator. As yet another alternative, an option to save, print, or both print and save a received fax to memory, may be a user settable or selectable feature. As noted above, the memory used to store a received fax may be resident in the multi-function printer device, or memory/storage associated with a connected general purpose processor based device, such as a PC. Resident memory may be shared by various functionalities of the present multi-function printer device. The multi-function printer device may also provide forwarding functions for received faxes. Additionally or alternatively, the present multi-function printer device may afford an ability to download faxes to a connected general purpose processor-based device., facilitating conversion and/or forwarding of received faxes or messages via email or the like.

Additionally and/or alternatively, if the call is not answered as a result of the generated rings, such as after a preset number of rings, voicemail functionality of the present multi-function printerer device may answer the call at 220 and initiate voicemail activity such as playing an outgoing message at 221 and recording an incoming message at 222. The indicator may be set at 109 to indicate a message has been recorded. Preferably, the number of rings may either be set by the user, such as through one of the aforementioned UIs, or preset in the multi-function printer device as a default.

As noted above, embodiments of the present invention may monitor the line at 230, following an answer at 225 for incoming activity, such as a voice. If no activity is detected at 203 the present systems and methods may initiate a fax receive at 205 and 206 in an attempt to synchronize, such as with a sending fax machine that is not employing an initiating fax tone.

1. A method for receiving facsimiles in a multi-function printer device, said method comprising:
answering, by said multi-function printer device, an incoming phone call;
playing, by said multi-function printer device, an outgoing communication;
monitoring, by said multi-function printer device, said incoming phone call to detect a facsimile tone;
generating, by said multi-function printer device, a ring on a telephone out-port of said device in response to no facsimile tone being detected during said monitoring; and
initializing said multi-function printer device to receive an incoming facsimile transmission in response to a facsimile tone being detected during said monitoring.

2. The method of claim 1 wherein said monitoring is carried out during said playing.

3. The method of claim 1 wherein said monitoring continues while generating said ring.

4. The method of claim 1 further comprising:
ceasing said ring by said multi-function printer device in response to said facsimile tone.

5. The method of claim 1 wherein said answering is carried out on a first incoming ring.

6. The method of claim 1 further comprising detecting said incoming phone call and answering said incoming phone call before a first incoming ring.

7. The method of claim 1 further comprising:
monitoring, by said multi-function printer device, for sound after said incoming call is answered; and
initializing said multi-function printer device to receive an incoming facsimile transmission in response to no sound being detected during the answered call.

8. The method of claim 1 further comprising:
answering, by said multi-function printer device, said incoming phone call after a predetermined number of the generated rings;
playing, by said multi-function printer device, an outgoing message; and
recording, by said multi-function printer device, an incoming message.

9. The method of claim 1 further comprising storing said facsimile in memory of said multi-function printer device.

10. The method of claim 1 further comprising storing said facsimile in memory of a general purpose processor based device connected to said multi-function printer device.

11. A multi-function printer device comprising:
means for printing media;
means for optically scanning media;
means for answering incoming phone calls;
means for sending and receiving facsimiles;
means for playing an outgoing communication;
means for monitoring said incoming phone calls and detecting an incoming facsimile tone;
means for generating a ring on a telephone out-line in response to said monitoring means not detecting an incoming facsimile tone; and
means for initializing the facsimile means to receive an incoming facsimile transmission in response to said monitoring means detecting an incoming facsimile tone.

12. The device of claim 11 wherein said monitoring means continues to monitor said incoming call for a facsimile tone while said generating means generates said ring.

13. The device of claim 11 further comprising:
means for monitoring said incoming call for sound after said incoming call is answered and initializing the facsimile means to receive an incoming facsimile transmission in response to no sound being detected during the answered call.

14. The device of claim 11 further comprising means for interfacing with a network.

15. The device of claim 11 further comprising means for receiving at least one memory device and means for downloading received faxes to said memory device.

16. The device of claim 11 wherein said scanning means comprises a flatbed optical scanner.

17. The device of claim 11 wherein said scanning means comprises a picture frame scanner.

18. A system for providing a multi-function printer device a capability for routing calls, said system comprising:
a multi-function printer device comprising:
a printer;
an optical scanner;
a call answering functionality; and
a facsimile functionality;
wherein said multi-function printer device answers and monitors incoming phone calls to internally intercept incoming calls, initialize said facsimile functionality to receive incoming facsimile transmissions, and generate a ring on a connected telephone for non-fax calls; and
a general purpose processor-based device selectively interfaced with said multi-function printer device and selectively powered.

19. The system of claim 18 wherein said facsimile functionality stores said incoming facsimiles to memory of said general purpose processor-based device.

20. The system of claim 18 wherein said general purpose processor-based device hosts a user interface adapted to receive user settings for said multi-function printer device.

21. The system of claim 18 wherein said multi-function printer device is a stand-alone device adapted to employ said facsimile and call answering functionalities, monitor said incoming phone calls and generate said ring independent of said interface with said general purpose processor-based device.

22. The system of claim 18 wherein said multi-function printer device is a stand-alone device adapted to employ said facsimile and call answering functionalities, monitor said incoming phone calls and generate said ring independent of a power status of said general purpose processor-based device.

23. The system of claim 18 wherein said multi-function printer device further comprises a wireless interface, interfacing said general purpose processor-based device with said multi-function printer device.

24. The system of claim 18 wherein said multi-function printer device further comprises voicemail functionality.

25. The system of claim 24 wherein a user interface hosted by said general purpose processor-based device enables recording of an outgoing message for use by said voicemail functionality.

26. The system of claim 24 wherein a microphone associated with said general purpose processor-based device is used to record an outgoing message for use by said voicemail functionality and a speaker associated with said general purpose processor-based device is used by said voicemail functionality for playing incoming messages.
